(19) United States
(12) Patent Application Publication
(10) Pub. No.: US 2023/0418278 A1
(43) Pub. Date: Dec. 28, 2023

(54) DOMESTIC APPLIANCES AND DENSE LOGGING OF DIAGNOSTIC DATA

(71) Applicant: Haier US Appliance Solutions, Inc., Wilmington, DE (US)

(72) Inventors: Jae Ho Ahn, Seoul (KR); Junho Kang, Seongnam (KR); Myunggeon Chung, Seoul (KR); Kyoung-june Yi, Youngin (KR); Seong Hoon Ryu, Seoul (KR); Je Kwon Yoon, Seongnam (KR)

(21) Appl. No.: 17/846,119

(22) Filed: Jun. 22, 2022

(51) Int. Cl. G05B 23/02; D06F 33/47; D06F 34/05

(52) U.S. Cl. CPC G05B 23/0283; D06F 33/47; D06F 34/05; G05B 23/0224; G05B 23/0221

(57) ABSTRACT

A domestic appliance may include a cabinet and a controller mounted to the cabinet. The controller may be configured to direct a diagnostic operation that includes receiving a dense diagnostic signal, transmitting historical use data from a plurality of historical memory slots from the controller of the domestic appliance, clearing the historical use data from the plurality of historical memory slots following transmitting historical use data, designating the plurality of historical memory slots as a unified logging slot for a single diagnostic cycle following clearing, initiating the single diagnostic cycle at the domestic appliance to collect single-cycle data within the unified logging slot, and transmitting the collected single-cycle data from the controller of the domestic appliance.

### FIELD OF THE INVENTION

The present subject matter relates generally to domestic appliances, and more particularly to systems and methods for selectively logging relatively large data sets for a diagnostic cycle.

### BACKGROUND OF THE INVENTION

Generally, modern domestic appliances (e.g., washing machine appliances, dryer appliances, refrigerator appliances, oven appliances, dishwasher appliances, etc.) are made up of multiple components that include or monitored by one or more electronic assemblies (e.g., an assembly or subsystem formed from one or more electrically driven or signal-generating components). For instance, one or more electronically controlled motors, valves, temperature sensors, may be provided. In many cases, certain data points are monitored and recorded in a domestic appliance (e.g., in response to a fault code or determination, each time a wash/dry cycle is performed, etc.). Over time, these historical data points may provide useful information in diagnosing various issues or concerns with the appliance. Generally, the amount of data points that can be saved is limited by the electronic storage or data slots provided with the appliance. As a result, it is typically only possible to record one or two data points for a corresponding system (e.g., max inlet temperature and max outlet temperature) during a single cycle.

Although having historical data is often useful, there may be instances in which a user or technician would benefit from having significantly more data points for a single cycle. Unfortunately, obtaining such data typically requires additional hardware, labor, or complexity. For instance, a service professional may be dispatched to a consumer or user's physical address (i.e., where the domestic appliance is installed) and use specialized hardware to record extensive data for a diagnostic cycle.

Recently, some domestic appliances have tried to incorporate features for connecting to and communicating wirelessly with a remote database or server, e.g., the cloud. Although this may permit certain data points to be transferred remotely, reliability or connection concerns may make it impractical to directly upload live data (e.g., without again requiring additional hardware, labor, or complexity). As a result, historical data must still be recorded on the appliance, and extensive data for a single cycle is unable to be recorded. Moreover, additional hardware may require additional training (e.g., to operate such hardware or interpret any collected data), preventing users or relatively unexperienced technicians, who might be less expensive or more readily available, from initiating diagnostic operations. Even relatively simple solutions to a problem/error on an appliance (e.g., problems or error that could be corrected by a user) may result in expensive or tedious actions to resolve the problem if a service professional must be dispatched to diagnose the problem.

As a result, it would be useful to provide an appliance or method with one or more features to permit increased data collection or otherwise improve data handling. Additionally or alternatively, it may be advantageous to permit a user or relatively untrained technician to initiate certain diagnostic operations (e.g., without having to wait for an experienced technician to be available in person).

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a domestic appliance is provided. The domestic appliance may include a cabinet and a controller mounted to the cabinet. The controller may be configured to direct a diagnostic operation that includes receiving a dense diagnostic signal, transmitting historical use data from a plurality of historical memory slots from the controller of the domestic appliance, clearing the historical use data from the plurality of historical memory slots following transmitting historical use data, designating the plurality of historical memory slots as a unified logging slot for a single diagnostic cycle following clearing, initiating the single diagnostic cycle at the domestic appliance to collect single-cycle data within the unified logging slot, and transmitting the collected single-cycle data from the controller of the domestic appliance.

In another exemplary aspect of the present disclosure, a method of operating a domestic appliance is provided. The method may include receiving a dense diagnostic signal. The method may further include transmitting historical use data from a plurality of historical memory slots from a controller of the domestic appliance and clearing the historical use data from the plurality of historical memory slots following transmitting historical use data and designating the plurality of historical memory slots as a unified logging slot for a single diagnostic cycle following clearing. The method may still further include initiating the single diagnostic cycle at the domestic appliance to collect single-cycle data within the unified logging slot and transmitting the collected single-cycle data from the controller of the domestic appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a domestic appliance according to exemplary embodiments of the present disclosure.

FIG. 2 provides a perspective view of the exemplary domestic appliance of FIG. 1 with a portion of a cabinet of the domestic appliance removed to reveal an interior of the domestic appliance.

FIG. 3 provides a schematic view of a system, including a domestic appliance, according to exemplary embodiments of the present disclosure.

FIG. 4 provides another schematic view of a system, including a domestic appliance and electronic storage therefor, according to exemplary embodiments of the present disclosure.

FIG. 5 provides a flow chart illustrating a method of operating a domestic appliance according to exemplary embodiments of the present disclosure.

FIG. 6 provides a depiction of an example machine-learned model according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

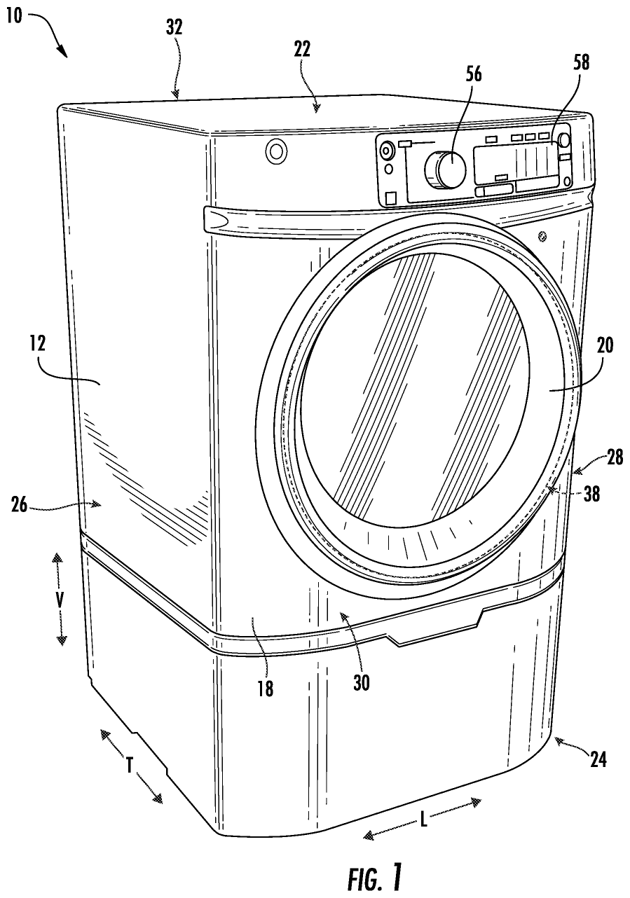

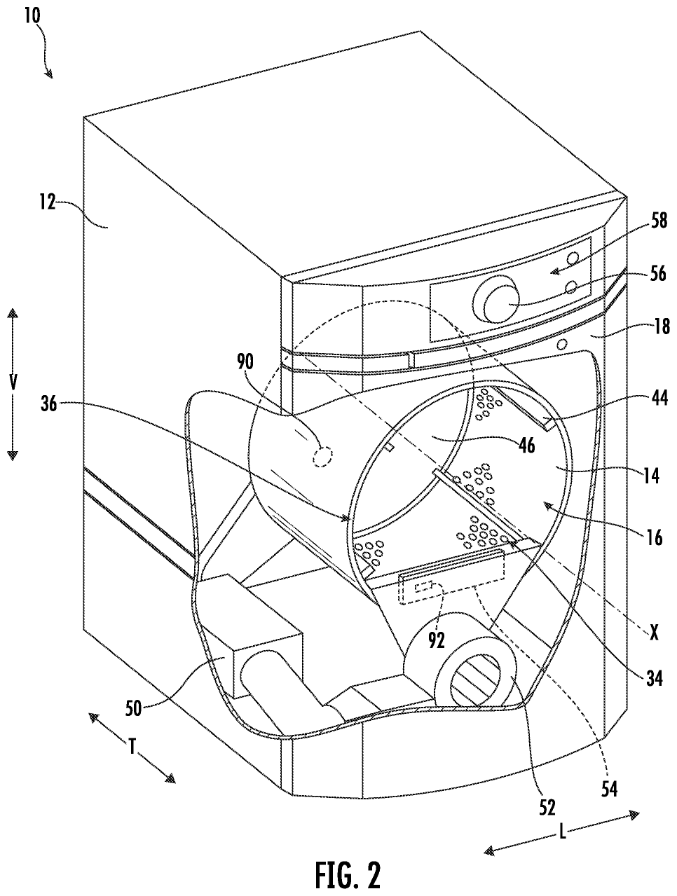

Referring now to the figures, FIGS. 1 and 2 provide perspective views of a domestic appliance 10 according to an exemplary embodiment of the present disclosure. In particular, domestic appliance 10 is provided as a dryer appliance. While described in the context of a specific embodiment of domestic appliance 10, using the teachings disclosed herein it will be understood that domestic appliance 10 is provided by way of example only. Other domestic appliances having different appearances and different features may also be utilized with the present subject matter as well. For example, domestic appliance 10 illustrated in FIGS. 1 and 2 is a laundry specific appliance and, specifically, an electric dryer appliance with electric heating element for heating air. In alternative exemplary embodiments, domestic appliance 10 may be a gas dryer appliance with gas burners for heating air. In further alternative exemplary embodiments, the laundry appliance may be provided as a washing machine appliance (e.g., vertical axis washing machine appliance, horizontal axis washing machine appliance), combination washer-dryer appliance, refrigerator appliance, oven appliance, dishwasher appliance, or other domestic appliance, as would be understood.

Domestic appliance 10 includes a cabinet 12 that extends between a top 22 and a bottom 24 along the vertical direction V, between a left side 26 and a right side 28 along the lateral direction L, and between a front 30 and a rear 32 along the transverse direction T. Within cabinet 12 is a drum or container 14 mounted for rotation about a substantially horizontal axis X. Drum 14 is generally cylindrical in shape and defines a chamber 16 for receipt of articles for drying. Thus, clothing articles and other fabrics may be loaded into chamber 16 of drum 14 and dried therein. In some embodiments, drum 14 defines a plurality of holes 34. A chamber opening 36 is defined by drum 14 in order to allow a user to access to drying chamber 16 through a coaxial opening 38 defined by cabinet 12 (e.g., for loading and unloading of articles, such as clothing or other fabrics) into drying chamber 16. A motor (not shown) is mounted within the cabinet 12 in mechanical communication with the drum 14 to rotate drum 14 about the defined drum rotation axis X, as would be understood.

A door 20 is movably mounted to cabinet 12 (e.g., on a front panel 18 of cabinet 12) to permit selective access to chamber 16 of drum 14 through opening 38. Optionally, one or more support rollers 40 may be provided (e.g., along a bottom surface or otherwise at a bottom half of drum 14 below rotation axis X). Such support rollers 40 may, for instance, be rotatably mounted within cabinet 12 at fixed positions (e.g., relative to cabinet 12 or rotation axis X) in rotational engagement with drum 14. Thus, rotation of drum 14 may prompt or cause rotation of a portion of each support roller 40. In particular, a corresponding wheel of each support roller 40 may roll along the outer surface of drum 14 as drum 14 itself rotates about rotation axis X. As a result, each support roller 40 may define a discrete roller axis that is parallel to rotation axis X.

In certain embodiments, a stationary flange 42 fixed within the cabinet 12 (e.g., coaxial to opening 38 and chamber opening 36). For instance, stationary flange 42 may be disposed about opening 38. As shown, stationary flange 42 is disposed between opening 38 and the drum 14 along the transverse direction T. In optional embodiments, appliance 10 includes a pedestal or drawer mounted at or defining a bottom portion of the main cabinet 12 body.

In some embodiments, a plurality of tumbling ribs 44 are provided within drum 14 to lift articles disposed therein and then allow them to tumble back to the bottom of drum 14 as drum 14 rotates. Drum 14 may include a rear wall 46 (e.g., rotatably supported within cabinet 12 by a suitable fixed bearing) defining a rear portion or extreme of drying chamber 16. Rear wall 46 can be fixed or can be rotatable. A plurality of holes receive hot air that has been heated by a heating system mounted within cabinet 12. Generally, heating system 50 includes one or more heating elements (e.g., electric elements or gas burners) and a blower fan 52 mounted along a ducted drying air path. During use, air may be drawn from drum 14 by blower fan 52. The air passes through a lint or screen filter 54 which traps lint particles. As the air passes from the blower fan 52, it is passed into the heating system 50. Heated air exits heating system 50 and returns to drum 14. After they have been dried, the articles are removed from drum 14 via opening 38.

In some embodiments, domestic appliance 10 includes a cycle selector knob 56 mounted on a cabinet control panel 58. Cycle selector knob 56 and other control inputs of cabinet control panel 58 are in communication with a controller. Signals generated in the controller operate a drum motor and heater assembly in response to a position of selector knob 56. Alternatively, a touch screen type interface may be provided.

A controller 110A may be positioned in a variety of locations throughout domestic appliance 10. For example, the controller 110A may be located at, adjacent to, or integral to cabinet control panel 58 in cabinet 12. In such an embodiment, input/output (“I/O”) signals may be routed between controller 110A and various operational components of domestic appliance 10. As an example, the various operational components of domestic appliance 10 may be in communication with controller 110A via one or more signal lines or shared communication buses. For instance, one or more electronic sensors 90, 92 may be in communication with controller 110A to detect conditions (e.g., temperature, humidity, weight, pressure, etc.) within domestic appliance 10 and transmit one or more corresponding signals to the controller 110A, as would be understood.

As an example, one or more temperature sensor 90 may be mounted on or within cabinet 12. Generally, temperature sensor 90 is operable to measure internal temperatures in domestic appliance 10. In particular, temperature sensor 90 may be provided as any suitable temperature sensor (e.g., thermistor, thermocouple, etc.) in communication (e.g., electrical communication or wireless communication) with controller 110A, and may transmit readings or signals to controller 110A as required or desired. In some embodiments, for example, temperature sensor 90 may be disposed in an air inlet duct, such as at an outlet of the inlet duct, which corresponds to an inlet to drum 14. Additionally or alternatively, for example, a temperature sensor may be disposed in drum 14, such as in chamber 16, at an air outlet of drum 14 such as in a vent duct downstream from the screen filter 54, or in any other suitable location within domestic appliance 10.

As an additional or alternative example, one or more dampness or moisture sensors 92 may be mounted on or within cabinet 12. Generally, moisture sensor 92 is operable to measure the dampness or moisture content of articles within chamber 16 during operation of domestic appliance 10. In particular, moisture sensor 92 may be provided as any suitable moisture sensor (e.g., capacitive moisture sensor, resistive moisture sensor, etc.) in communication (e.g., electrical communication or wireless communication) with controller 110A, and may transmit readings or signals to controller 110A as required or desired. Moisture sensor 92 may measure voltages associated with dampness or moisture content within the clothing, as is generally understood. In FIG. 2, moisture sensor 92 is shown disposed on a wall proximate to a screen filter 54. In alternative exemplary embodiments, moisture sensor 92 may be disposed at any other suitable location within domestic appliance 10 (e.g., on drum 14, rear wall 46, etc.).

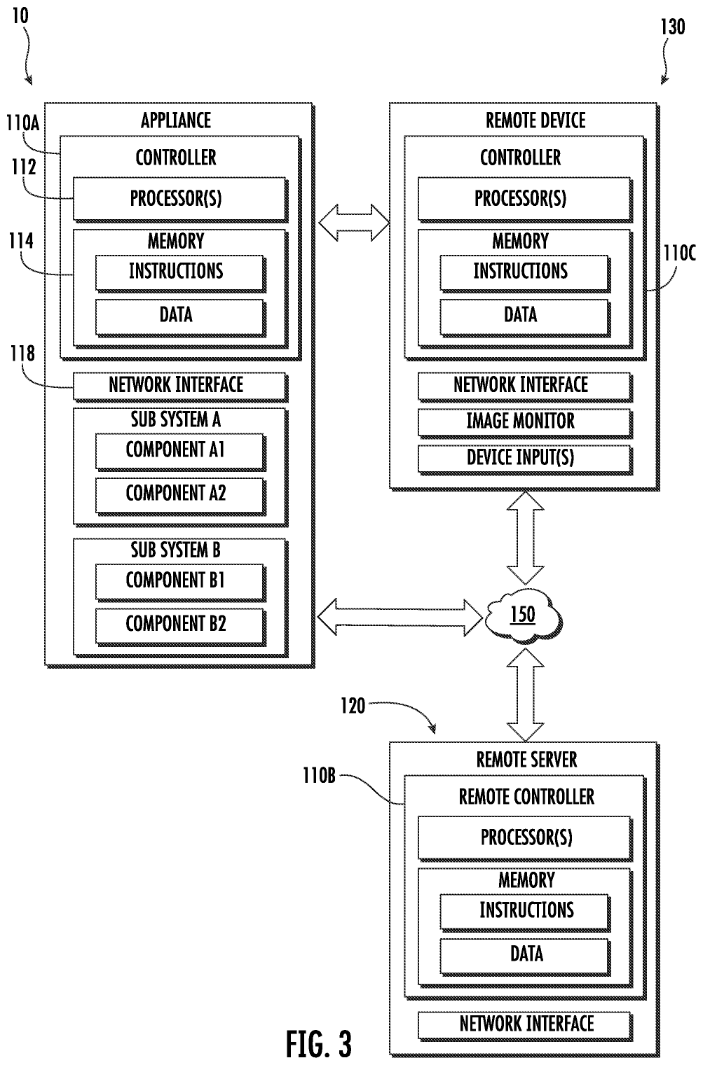

Turning now to FIG. 3, a schematic view is provided of appliance 10 in communication with one or more remote devices. As noted above, appliance 10 includes a controller 110A. in communication (e.g., electric or wireless communication) with various components (e.g., the drum motor, heating assembly 50, sensors 90, 92, etc.) of appliance 10. Such components may be organized as discrete sub-systems (e.g., sub-system A or sub-system B) to be monitored and record one or more signals therefrom. Controller 110 may include one or more processors 114 and one or more storage or memory devices (i.e., memory) 116. The one or more processors 114 can be any suitable processing device (e.g., a processor core, a microprocessor, a CPU, an ASIC, a FPGA, a microcontroller, etc.) and can be one processor or a plurality of processors that are operatively connected. The memory device 116 can include one or more non-transitory computer-readable storage mediums, such as RAM, DRAM, ROM, EEPROM, EPROM, flash memory devices, magnetic disks, etc., or combinations thereof. The memory device 116 may be a separate component from the processor 114 or may be included onboard within the processor 114.

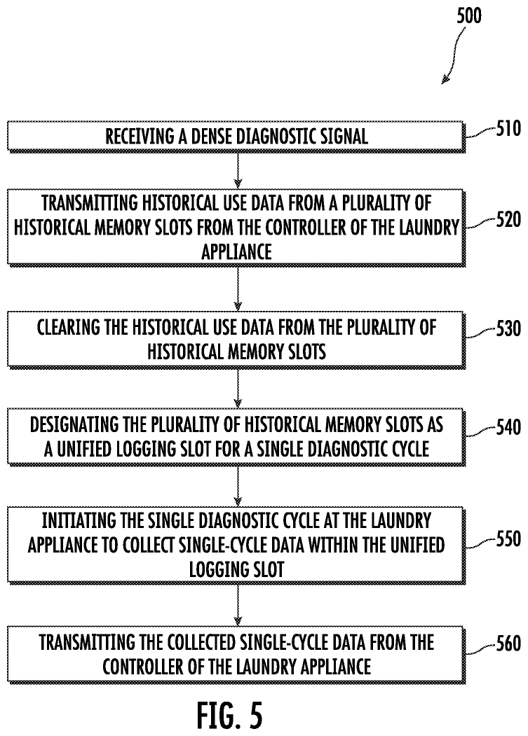

Generally, the storage or memory devices 116 can store data and instructions (e.g., non-transitory programming instructions) that are executed by the processors to cause domestic appliance 10 to perform operations. In certain embodiments, the instructions include a software package configured to operate appliance 10 or execute an operation or diagnostic routine (e.g., the exemplary method 500 described below with reference to FIG. 5). Additionally or alternatively, memory can store data (e.g., in one or more predefined slots) that can be obtained (e.g., received, accessed, written, manipulated, generated, created, stored, etc.) for further analysis of appliance performance, such as data received from the electronic components, sensor data, processed sensor data, input data, output data, cycle history data, usage profile data, recorded fault data, fault table/sequence data, or other data/information described herein.

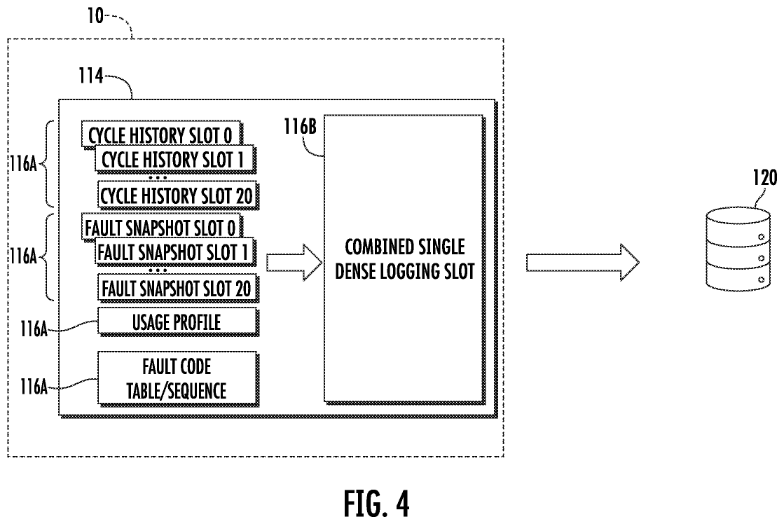

Turning briefly to FIG. 4, another schematic view of appliance 10, including controller 110A. As shown, multiple historical memory slots 116A are provided to each hold a discrete data entry (i.e., one entry of a corresponding data type). Generally, the number of slots is predefined and limited by the size or capacity of the memory device(s) 116 of controller 110A. Moreover, such slots are designated within controller 110A to hold predefined data types (e.g., historical data, fault snapshots, user profile, fault sequence/table, etc.). Such slots may be updated (e.g., provided with new data entries), for instance, on a rolling basis such that the corresponding data entries represent the most recent recorded entries and delete the oldest recorded entries as new data entries are recorded. In the illustrated embodiment of FIG. 4, the historical memory slots 116A include twenty cycle history slots (e.g., slots that each containing a data entry, such as maximum inlet temperature or maximum outlet temperature for a corresponding cycle), twenty fault snapshot slots (e.g., slots that each contain a discrete recorded fault instance for a corresponding cycle), at least one usage profile slot (e.g., slot that contains a recorded entry for a number of started cycles, completed cycles, cycle run times, reset counts, etc.), and at least one fault code table/sequence (e.g., slot that contains a code or key for how certain detected fault instances should be labeled or recorded). Nonetheless, it is understood that the number and type of historical memory slots 116A may vary according to the appliance type or model. Optionally, certain data entries (e.g., recorded within the historical data slots) may be transmitted to a separate remote server 120 (e.g., directly or through an intermediate remote device, such as a user device 130—FIG. 3—that receives such data entries, such as via a low power wireless connection, before transferring the data entries to remote server 120).

In some embodiments, the historical memory slots 116A may be converted or designated to store alternative data entries or types. For instance, two or more of the historical memory slots 116A (e.g., all) may be designated as combined single dense logging slot (i.e., unified logging slot 116B). In such a dense logging slot, all of the newly designated slots may store data entries related to a single cycle or operation (e.g., a single diagnostic cycle). In turn, multiple data points from the sub-assemblies or components of appliance 10 may be collected and recorded as single-cycle data (e.g., before being transferred to remote server 120, such as directly or indirectly). Following transfer of the single-cycle data, the dense logging slot may be returned or redesignated to the plurality of historical data slots.

Returning generally to FIG. 3, appliance 10 includes a network interface 118 that couples domestic appliance 10 (e.g., controller 110) to a network 150 such that domestic appliance 10 can transmit and receive information over network 150. Network 150 can be any wired or wireless network such as a WAN, LAN, or HAN.

In some embodiments, controller 110 includes a network interface 118 such that domestic appliance 10 can connect to and communicate over one or more networks (e.g., network 150) with one or more network nodes. Network interface 118 can be an onboard component of controller 110 or it can be a separate, off board component. Controller 110 can also include one or more transmitting, receiving, or transceiving components for transmitting/receiving communications with other devices communicatively coupled with domestic appliance 10. Additionally or alternatively, one or more transmitting, receiving, or transceiving components can be located off board controller 110.

Network 150 can be any suitable type of network, such as a local area network (e.g., intranet), wide area network (e.g., internet), low power wireless networks [e.g., Bluetooth Low Energy (BLE)], radio field wireless networks [e.g., Near Field Communications (NFC) pairing], cellular communications network, or some combination thereof and can include any number of wired or wireless links. In general, communication over network 150 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In some embodiments, the one or more remote servers 120 (e.g., web servers) are in operable communication with domestic appliance 10. The remote server 120 can be used to host a service platform or cloud-based application. Additionally or alternatively, remote server 120 can be used to host an information database (e.g., a machine-learned model, received data, or other relevant service data—optionally including intermediate processing data products). Remote server 120 can be implemented using any suitable computing device(s). Each remote server 120 generally includes a remote controller 110B having one or more processors and one or more memory devices (i.e., memory). The one or more processors can be any suitable processing device (e.g., a processor core, a microprocessor, a CPU, an ASIC, a FPGA, a microcontroller, etc.) and can be one processor or a plurality of processors that are operatively connected. The memory device can include one or more non-transitory computer-readable storage mediums, such as RAM, DRAM, ROM, EEPROM, EPROM, flash memory devices, magnetic disks, etc., or combinations thereof. The memory devices can store data and instructions (e.g., non-transitory programming instructions) that are executed by the processors to cause remote server 120 to perform operations. For example, instructions could be instructions for receiving/transmitting component signals (e.g., including data or information), analyzation results, machine-learned models, etc.

The memory devices of remote server 120 may also include data, such as data logs of appliance performance, analyzation results, machine-learned models, etc., that can be retrieved, manipulated, created, or stored by processors. The data can be stored in one or more databases. The one or more databases can be connected to remote server 120 by a high bandwidth LAN or WAN, or through one or more secondary networks. Optionally, the one or more databases can be split up so that they are located in multiple locales.

Additionally or alternatively, memory can store data that can be obtained (e.g., received, accessed, written, manipulated, generated, created, stored, etc.) for further analysis of appliance performance, such as data received from the electronic components, sensor data, processed sensor data, input data, output data, cycle history data, usage profile data, recorded fault data, fault table/sequence data, data indicative of machine-learned model(s) or other data/information described herein.

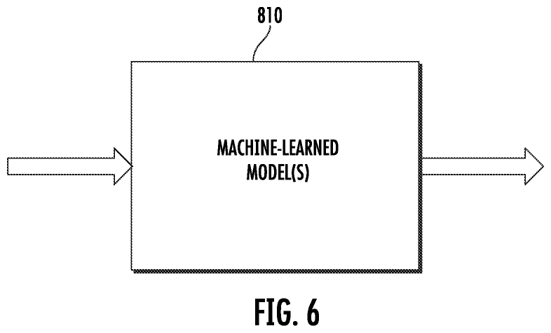

In some embodiments, remote controller 110B can store or include one or more machine-learned models 810 (FIG. 6). As examples, the machine-learned model(s) 810 (FIG. 6) can be or can otherwise include various machine-learned models such as, for example, neural networks (e.g., deep neural networks, etc.), support vector machines, decision trees, ensemble models, k-nearest neighbors models, Bayesian networks, or other types of models including linear models or non-linear models. Example neural networks include feed-forward neural networks (e.g., convolutional neural networks, etc.), recurrent neural networks (e.g., long short-term memory recurrent neural networks, etc.), or other forms of neural networks. The machine-learned models of the remote server 120 may be used by the domestic appliance 10 or user device 130 (e.g., by analyzing received historical data or single-cycle data from a combined dense logging slot). Additionally or alternatively, remote server 120 or user device 130 can train the machine-learned models through use of a model trainer (e.g., training algorithm), as would be understood. Optionally, such a model trainer may train machine-learned models based on a set of training data compiled from a plurality of different appliances.

Remote server 120 includes a network interface such that interactive remote server 120 can connect to and communicate over one or more networks (e.g., network 150) with one or more network nodes. Network interface can be an onboard component or it can be a separate, off board component. In turn, remote server 120 can exchange data with one or more nodes over the network 150.

In certain embodiments, a user device 130 is communicatively coupled with network 150 such that user device 130 can communicate with domestic appliance 10. For instance, user device 130 can communicate directly with domestic appliance 10 via network 150 [e.g., via a low energy wireless connection, such as Bluetooth Low Energy (BLE)]. Alternatively, user device 130 can communicate indirectly with domestic appliance 10 by communicating via network 150 with remote server 120 (e.g., directly or indirectly through one or more intermediate remote servers 120), which in turn communicates with domestic appliance 10 via network 150.

User device 130 can be any type of device, such as, for example, a personal computing device (e.g., laptop or desktop), a mobile computing device (e.g., smartphone or tablet), a gaming console or controller, a wearable computing device, an embedded computing device, a remote, or any other suitable type of user computing device. User device 130 can include one or more device controllers 110C. Device controller 110C can include one or more processors and one or more memory devices. The one or more processors can be any suitable processing device (e.g., a processor core, a microprocessor, an ASIC, a FPGA, a controller, a microcontroller, etc.) and can be one processor or a plurality of processors that are operatively connected. The memory device (i.e., memory) can include one or more non-transitory computer-readable storage mediums, such as RAM, ROM, EEPROM, EPROM, flash memory devices, magnetic disks, etc., and combinations thereof. The memory can store data and instructions which are executed by the processor to cause user device 130 to perform operations. Device controller 110C may include a network interface such that user device 130 can connect to and communicate over one or more networks (e.g., network 150) with one or more network nodes. Network interface can be an onboard component of device controller 110C or it can be a separate, off board component. Device controller 110C can also include one or more transmitting, receiving, or transceiving components for transmitting/receiving communications with other devices communicatively coupled with user device 130. Additionally or alternatively, one or more transmitting, receiving, or transceiving components can be located off board for device controller 110C.

Generally, a user may be in communication with domestic appliance 10 or one or more user devices 130. For instance, a user may wish to alternately operate domestic appliance 10 directly (e.g., through control panel 58) or remotely (e.g., through user device 130). In particular, a user may wish to control operational features that include activating portions or operations of domestic appliance 10.

User device 130 may include a device interface having one or more user inputs such as, for example, buttons, one or more cameras, or a monitor configured to display graphical user interfaces or other visual representations to user. For example, the device interface can include an image monitor. Generally, image monitor may be any suitable type of mechanism for visually presenting a digital image. For example, image monitor may be a liquid crystal display (LCD) panel, an organic light emitting diode (OLED) panel, etc. Thus, image monitor includes an imaging surface (e.g., screen or display panel) at which the digital image is presented or displayed as an optically-viewable picture (e.g., static image, dynamic or moving video, etc.) to a user. The optically-viewable picture may correspond to any suitable signal or data received or stored by domestic appliance 10 (e.g., at controller 110A) or remote server 120 (e.g., at remote controller 110B).

Referring now to FIG. 5, various methods (e.g., method 500) may be provided for use with a domestic appliance 10 or system in accordance with the present disclosure. In some embodiments, all or some of the various steps of the illustrated methods may be performed by one or more controllers (e.g., controller 110A) as part of an operation that such controller(s) are configured to initiate for an appliance (e.g., a service operation for domestic appliance 10 that is executed independently of a regular wash or dry operation of the appliance). Advantageously, extensive performance data (e.g., for a single cycle) may be collected without losing historical data or requiring additional hardware for the domestic appliance 10. Additionally or alternatively, a user or relatively untrained technician may initiate or start such methods (e.g., without having to wait for an experienced technician to be available in person).

FIG. 5 depicts steps performed in a particular order for the purpose of illustration and discussion. Those of ordinary skill in the art, using the disclosures provided herein, will understand that (except as otherwise indicated) the steps of any of the methods disclosed herein can be modified, adapted, rearranged, omitted, or expanded in various ways without deviating from the scope of the present disclosure.

At 510, the method 500 includes receiving a dense diagnostic signal. The dense diagnostic signal may be prompted, for instance, by an input or command to perform a diagnostic cycle on the appliance. For instance, a user or technician may input a command for the diagnostic cycle at the control panel of the appliance or on a remote device connected to the appliance, as described above. Thus, in response to an input or command for the domestic appliance to perform a diagnostic cycle, the dense diagnostic signal may be transmitted to and received by the controller of the appliance.

At 520, the method 500 includes transmitting historical use data from a plurality of historical memory slots from the controller of the domestic appliance (e.g., to a remote server). As described above, the storage or memory of the domestic appliance may include a plurality of historical memory slots. Over time (e.g., prior to method 500), the controller of the domestic appliance may collect and record historical use data (e.g., data entries for a cycle history, fault snapshot, usage profile, fault code, etc.) within the historical memory slots. In turn, such recorded historical use data may be sent out from the domestic appliance (e.g., via one or more wireless networks). For instance, the data at 520 may be transmitted to a remote server in response to 510. Such data may be transmitted directly to the remote server (e.g., via the one or more wireless networks) or, alternatively, through an intermediary remote device (e.g., user device, as described above, such as through a low power wireless network). Thus, prior to 520 (e.g., in response to 510 or prior to method 500, generally), the domestic appliance may wirelessly connect to the remote server or intermediary remote device.

At 530, the method 500 includes clearing the historical use data from the plurality of historical memory slots following 520. For instance, in response to 520 or in response to confirmation of reception of the historical use data from the remote server, the controller of the domestic appliance may wipe (or label for deletion) the historical use data from the historical memory slots.

At 540, the method 500 includes designating the plurality of historical memory slots as a unified logging slot for the single diagnostic cycle. Specifically, 540 may follow 520 or 530 (e.g., in response to the same). As part of the designation, the slots may be configured, permitted, or apportioned to receive a new data type than they previously received (e.g., prior to 540). For instance, the plurality of historical memory slots, which were previously grouped separately to collect discrete data types, may be grouped together to receive multiple data points from the sub-assemblies or components of the domestic appliance. Such multiple data points may be required to be part of (e.g., collected and recorded during) the diagnostic cycle and may, thus, be single-cycle data.

At 550, the method 500 includes initiating the single diagnostic cycle at the domestic appliance to collect single-cycle data within the unified logging slot. Generally, the single diagnostic cycle may require activation of one or more predetermined components of the domestic appliance (e.g., the drum motor, valves, heating assembly, etc.). The components may be directed or run according to one or more programmed conditions, as would be generally understood. Moreover, operation of such activation may be monitored during the diagnostic cycle (e.g., by one or more sensors or based on voltages to/from one or more components). Thus, diagnostic data or data points may be collected during or as part of the diagnostic cycle. Once collected, such diagnosis data points may be collected within the unified logging slot as single-cycle data.

At 560, the method 500 includes transmitting the collected single-cycle data from the controller of the domestic appliance. For instance, the data at 550 may be transmitted directly to the remote server (e.g., via the one or more wireless networks) or, alternatively, indirectly to the remote server through an intermediary remote device (e.g., user device, as described above, such as through a low power wireless network, before being transferred from the user device via a cellular communications network or other suitable network). Thus, prior to 560 (e.g., in response to 510 or prior to method 500, generally), the domestic appliance may wirelessly connect to the remote server or intermediary remote device.

Generally, the method 500 may provide for determining when the diagnostic cycle is complete (i.e., expires), as would be understood. Thus, expiration of the single diagnostic cycle may be determined. Optionally, 560 may be prompted in response to determining the expiration. Thus, 560 may be reserved until after the single diagnostic cycle is finished. Alternatively, 560 may be prompted and performed prior to expiration (e.g., based on a timed schedule or according to a data threshold for the collected single-cycle data to prevent the unified memory slots from being over filled such that some data is inadvertently lost). Thus, 560 may occur during the single diagnostic cycle.

In some embodiments, after 560 (e.g., following determined expiration of the single diagnostic cycle), the unified logging slot may be returned to a plurality of historical memory slots. As a result, historical use data may again be recorded within the slots previously designated for the plurality of historical memory slots. Thus, following 560, the method 500 may include redesignating the unified logging slot as a plurality of historical memory slots.

In additional or alternative embodiments, following 560 and after the collected single-cycle data is received by the remote server, the remote server may further analyze the collected single-cycle data. As an example, the collected single-cycle data may be compared to baseline data (e.g., collected from one or more appliances over time). As an additional or alternative example, the single-cycle data may be analyzed by one or more machine-learned models (e.g., to detect or predict improper operation of the appliance). The analyzation may generate a resultant diagnosis (e.g., detecting failure or one or more components, diagnosing a failure point, predicting future failure, or determining further service or examination is appropriate). In turn, the resultant diagnosis may be transmitted to the user (e.g., at the user's remote device). From the resultant diagnosis, the user may know or be prompted to resolve any issues with the appliance or otherwise schedule service by a technician.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A domestic appliance comprising:
a cabinet; and
a controller mounted to the cabinet, the controller being configured to direct a diagnostic operation comprising
receiving a dense diagnostic signal,
transmitting historical use data from a plurality of historical memory slots from the controller of the domestic appliance,
clearing the historical use data from the plurality of historical memory slots following transmitting historical use data,
designating the plurality of historical memory slots as a unified logging slot for a single diagnostic cycle following clearing,
initiating the single diagnostic cycle at the domestic appliance to collect single-cycle data within the unified logging slot, and
transmitting the collected single-cycle data from the controller of the domestic appliance.

2. The domestic appliance of claim 1, wherein the historical use data and the collected single-cycle data are transmitted to a remote server.

3. The domestic appliance of claim 2, wherein the historical use data and the collected single-cycle data are transmitted directly to the remote server from the controller.

4. The domestic appliance of claim 2, wherein the historical use data and the collected single-cycle data are transmitted indirectly to the remote server from the controller through an intermediary remote device.

5. The domestic appliance of claim 4, wherein the intermediary remote device connects to the domestic appliance prior to receiving the dense diagnostic signal.

6. The domestic appliance of claim 5, wherein the intermediary remote device connects to the domestic appliance via a low power wireless network.

7. The domestic appliance of claim 1, wherein the diagnostic operation further comprises
determining expiration of the single diagnostic cycle,
wherein transmitting the collected single-cycle data is in response to determining expiration of the single diagnostic cycle.

8. The domestic appliance of claim 1, wherein the diagnostic operation further comprises
determining expiration of the single diagnostic cycle,
wherein transmitting the collected single-cycle data occurs prior to expiration of the single diagnostic cycle.

9. The domestic appliance of claim 1, wherein the diagnostic operation further comprises redesignating the unified logging slot as a plurality of historical memory slots following transmitting the collected single-cycle data.

10. A method of operating a domestic appliance, the method comprising:
receiving a dense diagnostic signal;
transmitting historical use data from a plurality of historical memory slots from a controller of the domestic appliance;
clearing the historical use data from the plurality of historical memory slots following transmitting historical use data;
designating the plurality of historical memory slots as a unified logging slot for a single diagnostic cycle following clearing;
initiating the single diagnostic cycle at the domestic appliance to collect single-cycle data within the unified logging slot; and
transmitting the collected single-cycle data from the controller of the domestic appliance.

11. The method of claim 10, wherein the historical use data and the collected single-cycle data are transmitted to a remote server.

12. The method of claim 11, wherein the historical use data and the collected single-cycle data are transmitted directly to the remote server from the controller.

13. The method of claim 11, wherein the historical use data and the collected single-cycle data are transmitted indirectly to the remote server from the controller through an intermediary remote device.

14. The method of claim 13, wherein the intermediary remote device connects to the domestic appliance prior to receiving the dense diagnostic signal.

15. The method of claim 14, wherein the intermediary remote device connects to the domestic appliance via a low power wireless network.

16. The method of claim 10, further comprising:
determining expiration of the single diagnostic cycle,
wherein transmitting the collected single-cycle data is in response to determining expiration of the single diagnostic cycle.

17. The method of claim 10, further comprising:
determining expiration of the single diagnostic cycle,
wherein transmitting the collected single-cycle data occurs prior to expiration of the single diagnostic cycle.

18. The method of claim 10, further comprising:
redesignating the unified logging slot as a plurality of historical memory slots following transmitting the collected single-cycle data.
